(19) United States
(12) Patent Application Publication
(10) Pub. No.: US 2021/0270480 A1
(43) Pub. Date: Sep. 2, 2021

(54) ENTERPRISE MANAGEMENT SYSTEM WITH ALARM AGGREGATION

(71) Applicant: Johnson Controls Technology Company, Auburn Hills, MI (US)

(72) Inventors: Sandip Salunke, Nashik (IN); Mark T. Fischbach, New Berlin, WI (US); Yogesh Jalkote, Pune (IN); Vivek V. Gupta, Menomonee Falls, WI (US)

(73) Assignee: Johnson Controls Technology Company, Auburn Hills, MI (US)

(21) Appl. No.: 16/805,513

(22) Filed: Feb. 28, 2020

(51) Int. Cl. F24F 11/32; F24F 11/52; G06F 16/9035; G08B 21/02

(52) U.S. Cl. CPC F24F 11/32; G08B 21/02; G06F 16/9035; F24F 11/52

(57) ABSTRACT

An enterprise management system includes a first subsystem located at a first geographic location and including a first building device, a second subsystem located at a second geographic location and including a second building device, and one or more memory devices having instructions stored thereon that, when executed by one or more processors, cause the one or more processors to perform operations including receiving first alarm data from the first subsystem, the first alarm data indicating an alarm condition for the first building device, receiving second alarm data from the second subsystem, the second alarm data indicating an alarm condition for the second building device, and providing aggregate alarm data on a user interface based on the first alarm data and the second alarm data, the aggregate alarm data indicating a total number of alarms for the system.

### BACKGROUND

The present disclosure relates generally to an enterprise management system and more specifically to alarm data associated with subsystems monitored by the enterprise management system. An enterprise management system is, in general, a high-level system configured to monitor, manage, and/or control a plurality building or equipment controllers. An enterprise management system can include, for example, a plurality of building management systems (BMSs) that further include an HVAC system, a security system, a lighting system, a fire alerting system, any other system that is capable of managing building functions or devices, or any combination thereof. Management of a large number and/or variety of building controllers and systems may benefit from the implementation of easy-to-use and easy-to-navigate user interfaces that provide a user or system manager with a quicker and more intuitive overview of overall system metrics.

### SUMMARY

One embodiment of the present disclosure is an enterprise management system. The system includes a first subsystem located at a first geographic location, the first subsystem includes a first building device, a second subsystem located at a second geographic location, the first geographic location different than the second geographic location and the second subsystem includes a second building device, and one or more memory devices having instructions stored thereon that, when executed by one or more processors, cause the one or more processors to perform operations including receiving first alarm data from the first subsystem, the first alarm data indicating an alarm condition for the first building device, receiving second alarm data from the second subsystem, the second alarm data indicating an alarm condition for the second building device, and providing aggregate alarm data on a user interface based on the first alarm data and the second alarm data.

In some embodiments, the operations further include receiving a user input indicating a parameter for filtering the aggregate alarm data, providing new aggregate alarm data based on the parameter, providing a new user interface configured to present the new aggregate alarm data, and displaying the new user interface via the user device.

In some embodiments, the operations further include determining an access level of a user of the user device and filtering the aggregate alarm data based on the access level of the user.

In some embodiments, the first subsystem and the second subsystem are different types of building subsystems.

In some embodiments, the operations further include mapping at least one of the first alarm data or the second alarm data to an associated one of the first building device or the second building device.

In some embodiments, the operations further includes decoding the first alarm data to determine an alarm message, a priority, and a time of occurrence for the alarm condition associated with the first building device and decoding the second alarm data to determine an alarm message, a priority, and a time of occurrence for the alarm condition associated with the second building device.

In some embodiments, the operations further include determining an automated control action based on at least one of the first alarm data or the second alarm data and initiating the automated control action.

In some embodiments, the operations further includes determining a severity for each of the first alarm data and the second alarm data, where the aggregate alarm data further indicates the total number of alarms for the system by severity.

In some embodiments, the aggregate alarm data is displayed as a graphic, the graphic presenting the total number of alarms for the system based on severity.

Another embodiment of the present disclosure is a method. The method includes receiving first alarm data for a first subsystem located at a first geographic location, the first alarm data indicating an alarm condition for a first device of the first subsystem, receiving second alarm data for a second subsystem located at a second geographic location, the second geographic location different than the first geographic location and the second alarm data indicating an alarm condition for a second device of the second subsystem, generating aggregate alarm data based on the first alarm data and the second alarm data, generating a user interface configured to present the aggregate alarm data, displaying the user interface via a user device, receiving, via the user interface, a user input indicating a parameter for filtering the aggregate alarm data, and reconfiguring the user interface based on the user input.

In some embodiments, the method further includes determining an access level of a user of the user device, and filtering the aggregate alarm data based on the access level of the user.

In some embodiments, the first subsystem and the second subsystem are different types of building subsystems.

In some embodiments, the method further includes mapping at least one of the first alarm data or the second alarm data to an associated one of the first device or the second device.

In some embodiments, the method further includes decoding the first alarm data to determine an alarm message, a priority, and a time of occurrence for the alarm condition associated with the first device and decoding the second alarm data to determine an alarm message, a priority, and a time of occurrence for the alarm condition associated with the second device.

In some embodiments, the method further includes determining an automated control action based on at least one of the first alarm data or the second alarm data and initiating the automated control action.

In some embodiments, the aggregate alarm data is displayed as a graphical element, the graphical element presenting the total number of alarms for the system based on severity.

Yet another embodiment of the present disclosure is an enterprise management system. The system includes a first subsystem located at a first geographic location, a second subsystem located at a second geographic location, the first geographic location different than the second geographic location, and a server. The server is configured to receive first alarm data indicating an alarm condition for the first subsystem, receive second alarm data indicating an alarm condition for the second subsystem, generate aggregate alarm data based on the first alarm data and the second alarm data, the aggregate alarm data indicating a total number of alarms for the system, display a user interface configured to present the aggregate alarm data via a user device, receive, via the user interface, a user input indicating a parameter for filtering the aggregate alarm data, and reconfigure the user interface based on the user input.

In some embodiments, the server is configured to determine an automated control action based on at least one of the first alarm data or the second alarm data and initiate the automated control action.

In some embodiments, the server is configured to determine an access level of a user of the user device and filter the aggregate alarm data based on the access level of the user.

In some embodiments, the first subsystem and the second subsystem are different types of building subsystems.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a schematic of a waterside system which can be used as part of the HVAC system of FIG. 1, according to some embodiments.

FIG. 3 is a diagram of an airside system which can be used as part of the HVAC system of FIG. 1, according to some embodiments.

FIG. 4 is a diagram of a BMS which can be used in the building of FIG. 1, according to some embodiments.

FIGS. 5A and 5B are diagrams of enterprise management systems, according to some embodiments.

FIG. 6 is a diagram of an enterprise manager for the enterprise management system of FIG. 5, according to some embodiments.

FIG. 7 is an architecture implemented by the enterprise manager of FIG. 6, according to some embodiments.

FIG. 8 is a process for aggregating alarm data, according to some embodiments.

FIG. 9 is an example user interface for presenting aggregate alarm data, according to some embodiments.

FIG. 10 is an alternate configuration of the user interface of FIG. 9, according to some embodiments.

FIG. 11 is an example graphical element for presenting aggregate alarm data in the user interface of FIG. 10, according to some embodiments.

FIG. 12 is an example user interface for an enterprise management system, according to some embodiments.

FIGS. 13A and 13B are example user interfaces for presenting aggregate alarm data, according to some embodiments.

FIG. 14 is a process for filtering aggregate alarm data, according to various embodiments.

FIG. 15 illustrates the user interface of FIG. 12 with a filter parameter applied, according to some embodiments.

FIG. 16 illustrates the user interface of FIG. 13 with the filter parameter applied, according to some embodiments.

FIG. 17 illustrates the user interface of FIGS. 12 and 15 filtered to a single site, according to some embodiments.

FIG. 18 is a user interface for presenting aggregate alarm data for a single site, according to some embodiments.

FIG. 19 is a user interface for presenting alarm data for a particular building device, according to some embodiments.

### DETAILED DESCRIPTION

### Overview

Referring generally to the FIGURES, an enterprise management system for communicating with, monitoring, and controlling a plurality of building and equipment controllers is shown. In some embodiments, the enterprise management system is in communication with a plurality of building management systems (BMS) or other building controllers. The enterprise management system may provide a user with a single interface for interacting with the plurality of building or equipment controllers (e.g., BMSs). In this manner, the enterprise management system may provide a user-friendly experience for improved management over multiple building systems, sites, campuses, or locations.

The enterprise management system described herein may provide a user with a high-level overview of system metrics, such as energy and thermal data, equipment statuses, alarms, etc. Notably, alarms may be received from a variety of different types of building equipment, or from various controllers that monitor and control the building equipment. Additionally, the enterprise management system may manage, control, and/or monitor multiple sites, campuses, buildings, etc. that are not located at a singular geographic location, and alarms may be received from any number of said remote sites and systems. Therefore, an improved enterprise management system may provide an overview of alarm data (i.e., aggregate alarm data) for all of the site, campuses, buildings systems, etc. monitored, managed, and/or controlled by the enterprise management system.

### Building Management System

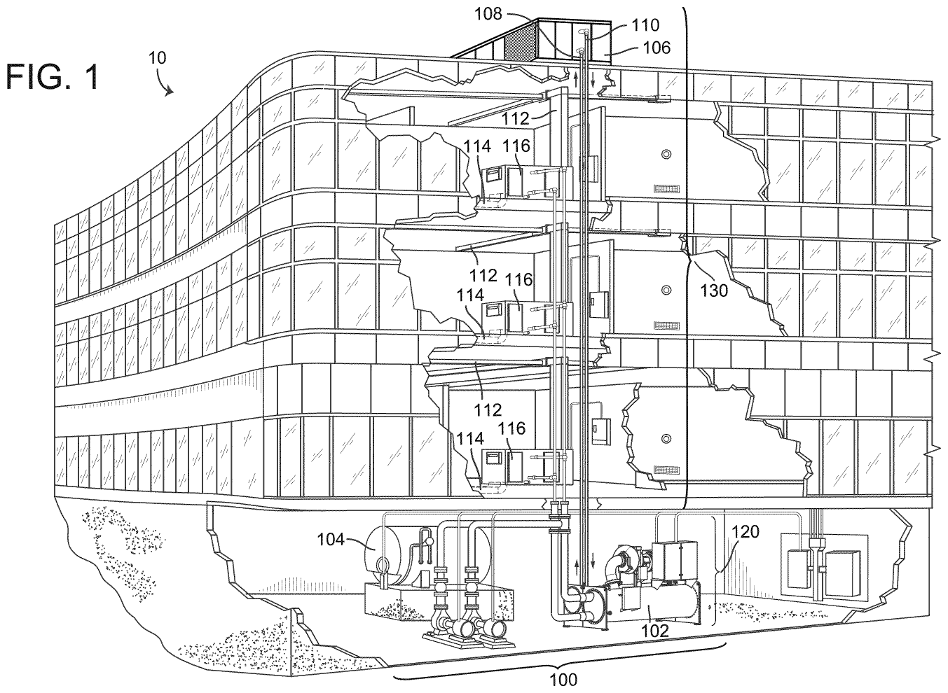

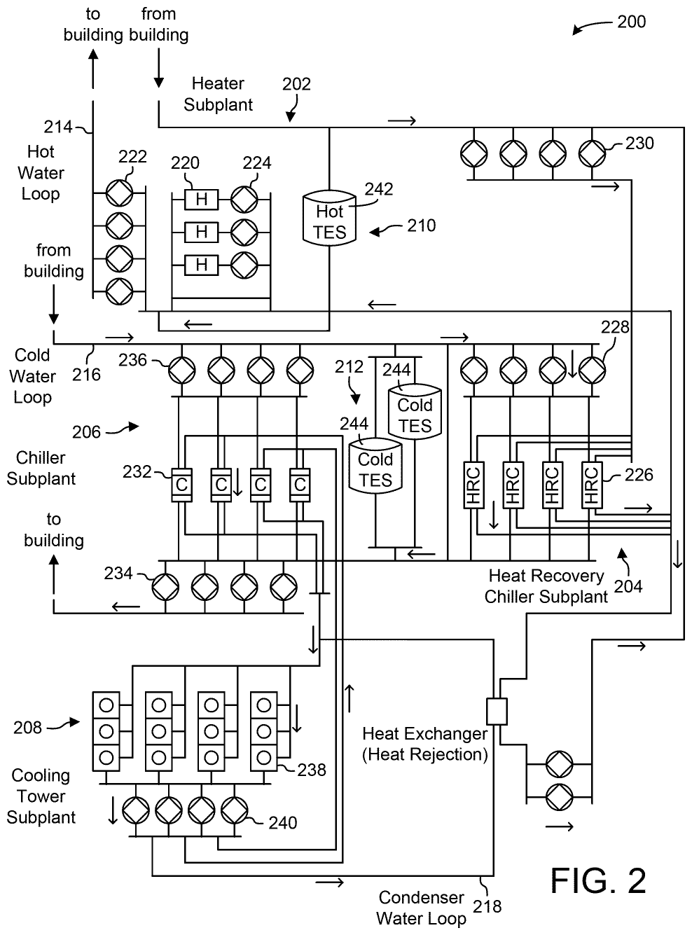

Referring now to FIG. 1, a perspective view of a building 10 is shown. Building 10 is served by a BMS (sometimes referred to as a building automation system (BAS)). The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. In some embodiments, waterside system 120 is replaced with a central energy plant such as central plant 200, described with reference to FIG. 2.

Still referring to FIG. 1, HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a central plant 200 is shown, according to an exemplary embodiment. In brief overview, central plant 200 may include various types of equipment configured to serve the thermal energy loads of a building or campus (i.e., a system of buildings). For example, central plant 200 may include heaters, chillers, heat recovery chillers, cooling towers, or other types of equipment configured to serve the heating and/or cooling loads of a building or campus. Central plant 200 may consume resources from a utility (e.g., electricity, water, natural gas, etc.) to heat or cool a working fluid that is circulated to one or more buildings or stored for later use (e.g., in thermal energy storage tanks) to provide heating or cooling for the buildings. In various embodiments, central plant 200 may supplement or replace waterside system 120 in building 10 or may be implemented separate from building 10 (e.g., at an offsite location).

Central plant 200 is shown to include a plurality of subplants 202-212 including a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO₂, etc.) may be used in place of or in addition to water to serve the thermal energy loads. In other embodiments, subplants 202-212 may provide heating and/or cooling directly to the building or campus without requiring an intermediate heat transfer fluid. These and other variations to central plant 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in central plant 200 (e.g., pumps 222, 224, 228, 230, 234, 236, and/or 240) or pipelines in central plant 200 include an isolation valve associated therewith. Isolation valves may be integrated with the pumps or positioned upstream or downstream of the pumps to control the fluid flows in central plant 200. In various embodiments, central plant 200 may include more, fewer, or different types of devices and/or subplants based on the particular configuration of central plant 200 and the types of loads served by central plant 200.

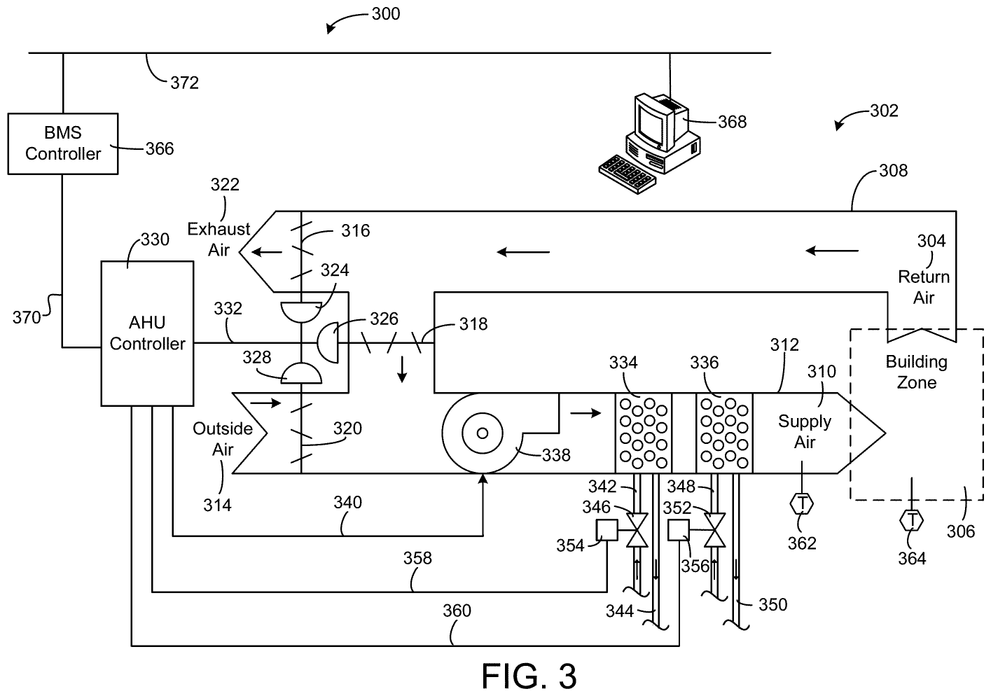

Referring now to FIG. 3, a block diagram of an airside system 300 is shown, according to an example embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, duct 112, duct 114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362 and 364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

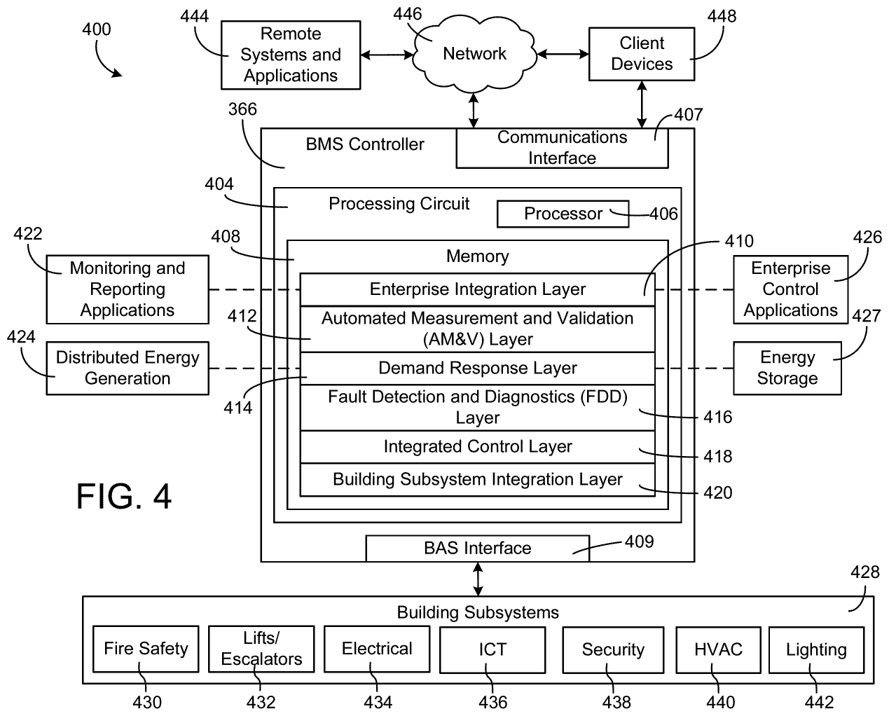

Referring now to FIG. 4, a block diagram of a BMS 400 is shown, according to an example embodiment. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an example embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an example embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated super system. In an example embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other example embodiments, FDD layer 416 is configured to provide “fault” events to integrated control layer 418 which executes control strategies and policies in response to the received fault events. According to an example embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Enterprise Management System

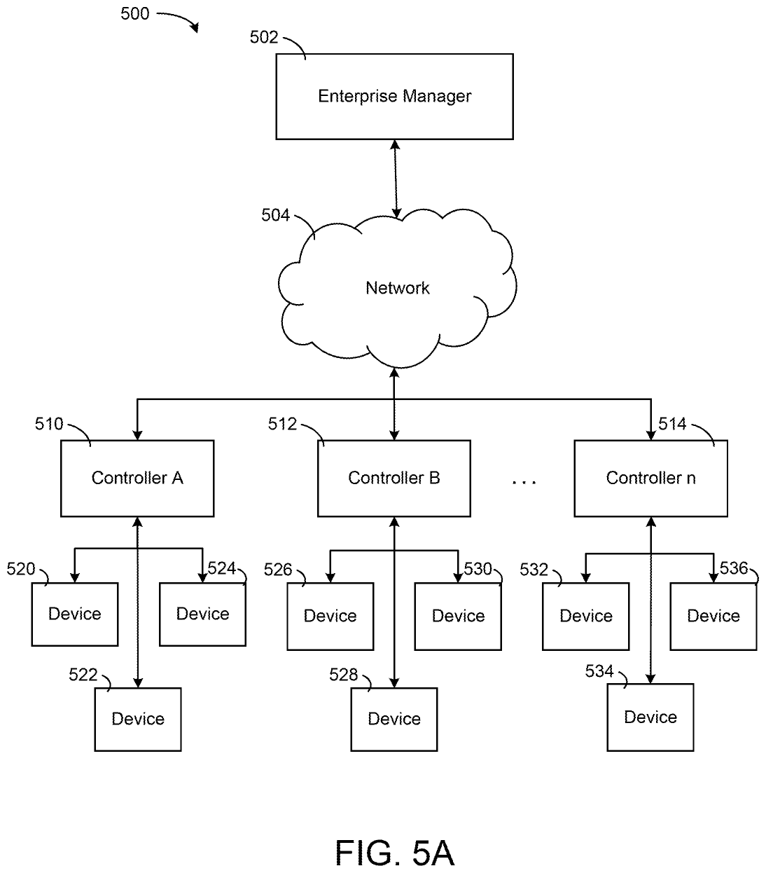

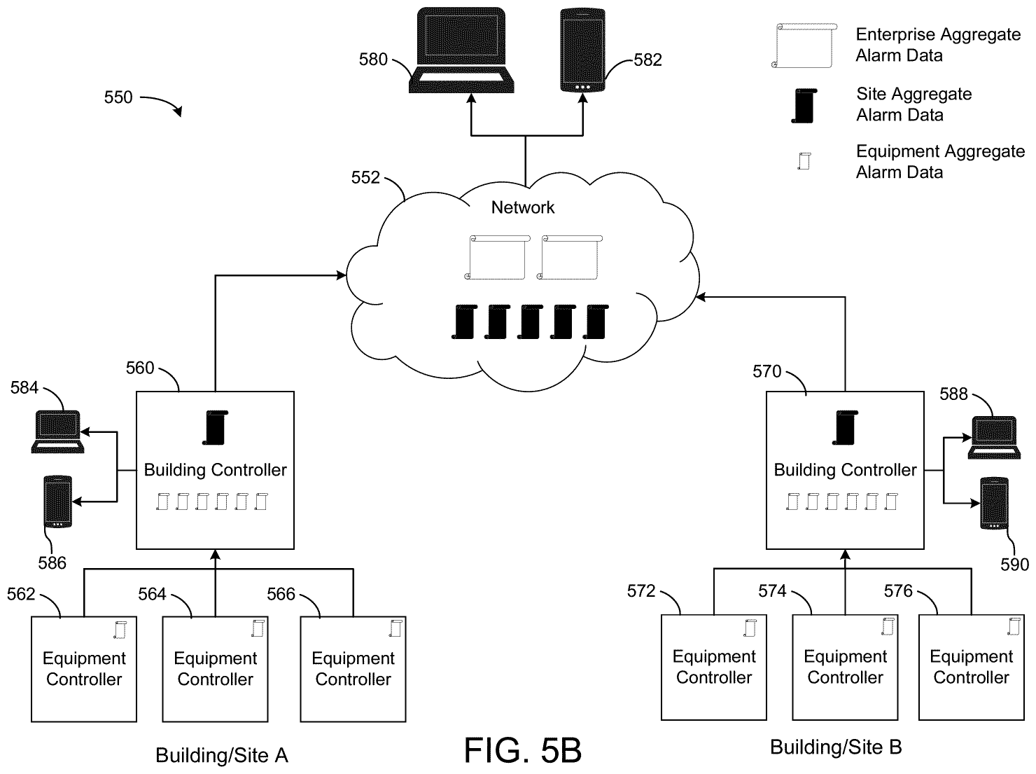

Referring now to FIG. 5A, a diagram of an enterprise management system 500 is shown, according to some embodiments. System 500 may be a system for monitoring, managing, controlling, and/or otherwise interacting with one or more building controllers, device, and/or equipment. For example, system 500 may provide means for a user (e.g., a system or enterprise administrator, a building or site manager, etc.) to interact with multiple building subsystems and/or multiple building controllers from a single interface (e.g., a single user device, a single server, etc.). More generally, system 500 may provide means for interacting with multiple building subsystems, controllers, equipment, etc., without having to interact with each particular device or multiple interfaces.

As shown, system 500 includes an enterprise manager 502. Enterprise manager 502 may be a single device (e.g., one server, one user device, etc.) or may be distributed across multiple devices (e.g., multiple servers or user devices). Enterprise manager 502 may provide means for monitoring, managing, controlling, or otherwise interacting with multiple building subsystems, controllers, equipment, etc. Enterprise manager 502 may communicate with said devices via a network 504, for example. Network 504 may be any type of public or private intranet or internet such a local area network (LAN), a wide area network (WAN), the Internet, a cellular network, etc. As an example, network 504 may be a private network of a campus or a building. In some embodiments, network 504 may be a virtual private network (VPN). In various embodiments, network 504 may be the same as, or functionally equivalent to, network 446, or may be communicably coupled to network 446.

Multiple controllers are shown in communication with network 504, including a controller 510 (“Controller A”), a controller 512 (“Controller B”), and a controller 514 (“Controller n”). In some embodiments, any number of controllers (e.g., 10, 50, 100+) may be in communication with network 504. Each of controllers 510-514 may be a building controller, a subsystem controller, an equipment controller, or another type of controller associated with a building, site, or campus. In some embodiments, each of controllers 510-514 may be BMS controllers (e.g., such as BMS controller 366) associated with a particular building or a particular subsystem (i.e., a type of system). Controller 510 may be a BMS controller (e.g., BMS controller 366), a security system controller, an HVAC device controller, etc., for example.

In some embodiments, each of controllers 510-514 may be associated with a building in a separate geographic location. For example, controller 510 may be a controller (e.g., a BMS) for a building (i.e., campus, site) located in Wisconsin, USA, while controller 512 may be a controller for a building located in Kansas, USA. In this regard, controllers from any geographic location may communicate with network 504 and, thereby, enterprise manager 502 may remotely interact with controllers from any geographic location.

As shown, each of controllers 510-514 may manage and/or control a plurality of devices, such as devices 520-536. In some embodiments, device 520-536 are any type of building or subsystem equipment associated with a building or a controller (e.g., controllers 510-514). As described above, for example, devices 520-536 may be any type of HVAC device or subsystem, security device or subsystem, lighting device or subsystem, fire alarming device or subsystem, etc. As a specific but non-limiting example, device 520 may be an HVAC system or a chiller of an HVAC system, while device 522 may be a security system or an alarm of a security system. In general, devices 520-536 may be any combination of equipment, device, or subsystem associated with a building.

Generally, enterprise manager 502 receives data from one or more of controllers 510-514 via network 504. Data may include, for example, current or historical equipment parameters, operating data, equipment states, sensor values, alarm data, or any other metric. In a use-case example, controller 510 may identify an alarm condition for device 520, or may receive an indication of an alarm from device 520, and may transmit, via network 504, alarm data to enterprise manager 502. Enterprise manager 502 may initiate an automatic control action in response to the alarm data, where the automatic control action may include presenting the alarm data to a user (e.g., via an interface), initiating an alert, sending a control command to controller 510 to correct the alarm, logging the alarm data, etc. The processes and methods implemented by enterprise manager 502 in response to receiving alarm data from a controller are discussed in detail below.

Referring now to FIG. 5B, a diagram of an enterprise management system 550 is shown, according to some embodiments. In some embodiments, system 550 may be wholly or partially incorporated into system 500. In other embodiments, system 500 may be wholly or partially incorporated into system 550. As an example, system 550 may be a specific implementation of system 500 (i.e., a particular embodiment of system 500). It should be appreciated that the particular embodiment shown in FIG. 5B is used as an example of an implementation of an enterprise system such as system 500 and is not intended to be limiting.

System 550 is shown to include a network 552. Similar to network 504, described above, network 552 may be any type of public or private intranet or internet such a local area network (LAN), a wide area network (WAN), the Internet, a cellular network, etc. As an example, network 552 may be a private network of a campus or a building. In some embodiments, network 552 may be a virtual private network (VPN). In various embodiments, network 552 may be the same as, or functionally equivalent to, network 446, or may be communicably coupled to network 446.

In communication with network 552 are multiple building controllers 560 and 570. In some embodiments, building controllers 560 and 570 are similar to, or the same as, controllers 510-514, described above with reference to FIG. 5A. Building controllers 560 and 570 may be central controllers for individual buildings or sites of system 550. As an example, each of building controllers 560 and 570 may be a BMS, as described above, or another type of building controller (e.g., a Verasys® Smart Building Hub). In some embodiments, each of building controllers 560 and 570 may be associated with a building in a separate geographic location. For example, building controller 560 may be a controller (e.g., a BMS) for a building (i.e., campus, site) located at a first state, city, country, zipcode, etc., while controller 512 may be a controller for a building located at a second, different state, city, country, zipcode, etc. In some embodiments, system 550 may include more controllers than those shown, for any number of buildings or sites.

Building controllers 560 and 570 are shown to communicate with a plurality of equipment controllers, including equipment controllers 562-566 and equipment controllers 572-576 respectively. Equipment controllers 562-566 and 572-576 may be similar to, or the same as, and of devices 520-536 described above. Equipment controllers 562-566 and 572-576 may be individual controllers for building devices (e.g., an HVAC device, a security device, etc.), equipment, building subsystems (e.g., HVAC, electrical, fire safety, etc.), etc. More generally, equipment controllers 562-566 and 572-576 may be any type of building or subsystem equipment associated with one of building controllers 560 or 570. As a specific but non-limiting example, equipment controller 562 may be a controller for a chiller of an HVAC system. In general, devices 520-536 may be any combination of equipment, device, or subsystem associated with a building.

In some embodiments, each of equipment controllers 562-566 and 572-576 may identify, generate, and/or aggregate alarm data for connected equipment and/or devices. More generally, each of equipment controllers 562-566 and 572-576 may generate aggregate alarm data from multiple points associated with the controller (e.g., from multiple sensors associated with a device). Equipment controllers 562-566 and 572-576 may identify active and historical alarms, alarm severities, alarm IDs, alarm messages/text, alarm creation times, alarm clear times, etc. As an example, where equipment controller 562 is a controller for a chiller, equipment controller 562 may receive data from multiple sensors or other points of the chiller and determine and/or generate an alarm based on the received data. In another example, controller 562 may receive an indication of the alarm from the chiller itself.

Equipment aggregate alarm data may be received by building controllers 560 and/or 570 from associated equipment controllers 562-566 and/or 572-576. In some embodiments, building controllers 560 and 570 may store the received equipment aggregate data, such as in a local or network database. Building controllers 560 and 570 may further aggregate the received equipment alarm data to generate site aggregate alarm data. Said site aggregate alarm data may include alarm information for any number of equipment controllers (e.g., equipment controllers 562-566 and 572-576) connected to a respective building controller. For example, building controller 560 may receive equipment aggregate data from each of equipment controllers 562-566. In this manner, site aggregate alarm data may present an overview of alarm data for an entire site (i.e., building) managed, controlled, or otherwise monitored by one of building controllers 560 or 570.

In some embodiments, site aggregate alarm data may be transmitted to user devices for presenting to a user of a user device. For example, site aggregate alarm data for building controller 560 may be transmitted to at least one of user devices 584 or 586. Likewise, site aggregate alarm data for building controller 570 may be transmitted to at least one of user devices 588 or 590. User devices 584-590 may be any electronic devices that allow a user to interact with building controllers 560 and/or 570, such as through a user interface. Examples of user devices include, but are not limited to, mobile phones, electronic tablets, laptops, desktop computers, workstations, and other types of electronic devices. User devices 584-590 may be similar to client device 368 as described above, for example. User devices 584-590 may display a user interface (UI) on a display, thereby enabling a user to easily view alarm data and other data associated with system 550.

At a local UI dashboard, presented via user devices 584-590, a user may view and/or manipulate the site aggregate alarm data. In some embodiments, the user may be presented with information such as a total number of alarms for the correspond one of building controllers 560 or 570. The user may also be presented with specific alarm information, such as alarm priority/severity, alarm type, alarm times, etc. In this manner, the local UI dashboards presented via user devices 584-590 may provide an overview of aggregate alarm data for a single site or building, which may be beneficial for a local user (e.g., a site or building administrator or manager).

In some embodiments, the site aggregate alarm data may be transmitted by building controller 560 and 570 to network 552, as shown. In some embodiments, network 552 may include a database and/or a server, for storing and/or processing the site aggregate alarm data. In some embodiments, an enterprise manager such as enterprise manager 502 may be wholly or partially implemented via network 552. In some embodiments, the enterprise manager (e.g., enterprise manager 502) may be wholly or partially implemented via one of user devices 580 and 582. As an example, enterprise manager 502 may be implemented via network 552 or at least a portion of enterprise manager 502 may be implemented via user devices 580 and/or 582.

As shown, site aggregate alarm data may be further processed and/or stored at network 552. For example, site aggregate alarm data from each of building controllers 560 and 570 may be aggregated to generate enterprise aggregate data. The enterprise aggregate alarm data may include alarm data for any number of building and/or equipment controllers of an enterprise management system (e.g., system 550). In some embodiments, the site aggregate alarm data may be aggregated by at least one of user devices 580 and 582 and the enterprise aggregate alarm data may transmitted back to network 552 for storage. In other embodiments, the site aggregate alarm data may be aggregated by components of network 552 and the enterprise aggregate data may be transmitted to user devices 580 and/or 582.

The enterprise aggregate data may be presented via user devices 580 and/or 582 to provide a user (e.g., an enterprise administrator) with a high-level overview of alarm data for multiple buildings, sites, devices, equipment, etc. associated with the enterprise management system (e.g., system 550). The enterprise aggregate data may be filtered by the user based on various parameters, such that the user may be presented with aggregate alarm data for specific subsets of equipment, sites, buildings, etc. As described in detail below, the enterprise aggregate data may be filtered by any number of parameters, such as by customer, location of a site or controller (e.g., state, country, zip code, etc.), alarm priority/severity, alarm type/code, user credentials/access level, etc. In some embodiments, a user may filter the enterprise aggregate data down to the site, building, and/or equipment levels, to view alarm data aggregated at any level.

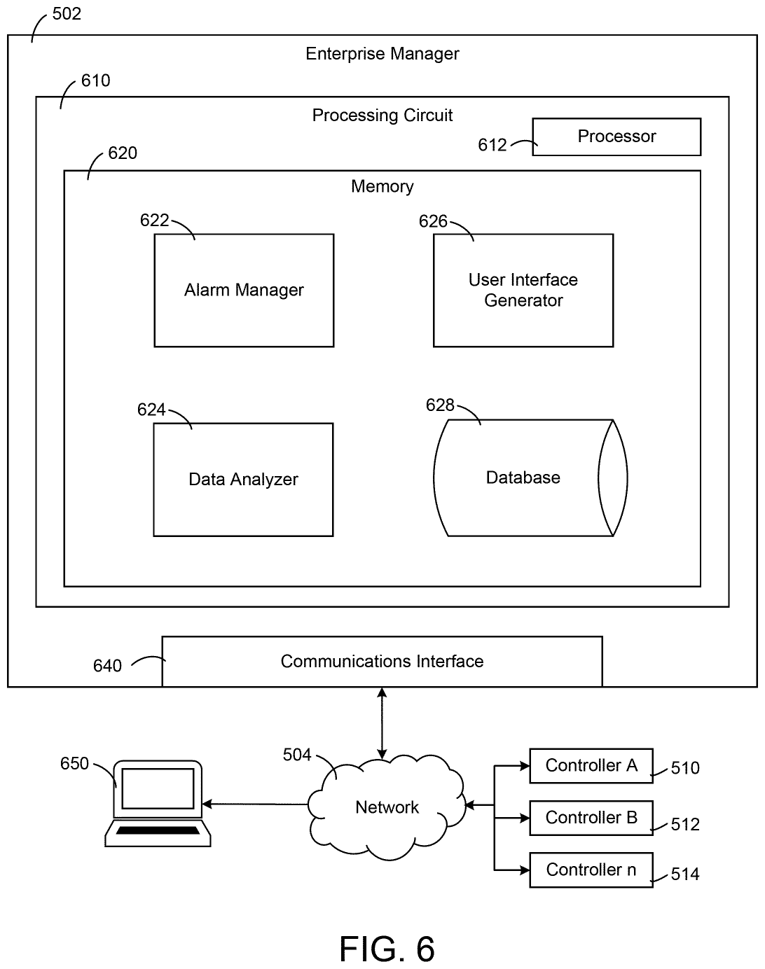

Referring now to FIG. 6, a diagram of enterprise manager 502 of system 500 is shown, according to some embodiments. In some embodiments, enterprise manager 502 is implemented within a single computer (e.g., one server, one housing, etc.). In various other embodiments, enterprise manager 502 can be distributed across multiple servers or computers (e.g., that can exist in distributed locations). Enterprise manager 502 may provide means for monitoring, managing, controlling, or otherwise interacting with the various components of system 500, as described above. In some embodiments, enterprise manager 502 may be in communication with any number of building or equipment controllers (e.g., 10, 50, 100 controllers). For example, enterprise manager 502 may provide means for monitoring, managing, or controlling one or more of controllers 510-514.

Enterprise manager 502 is shown to include a processing circuit 610 including a processor 612 and memory 620. It will be appreciated that these components can be implemented using a variety of different types and quantities of processors and memory. For example, processor 612 can be implemented as a general purpose processor, an application specific integrated circuit (ASIC), one or more field programmable gate arrays (FPGAs), a group of processing components, or other suitable electronic processing components.

Memory 620 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 620 can be or include volatile memory or non-volatile memory. Memory 620 can include database components, object code components, script components, or any other type of information structure for supporting the various activities and information structures described in the present application. According to an example embodiment, memory 620 is communicably connected to processor 612 via processing circuit 610 and includes computer code for executing (e.g., by processing circuit 610 and/or processor 612) one or more processes described herein.

Enterprise manager 502 is also shown to include a communications interface 640 configured to send data to and receive data from a user device 650 and/or controllers 510-514. Processing circuit 610 can be communicably connected to communications interface 640 such that processing circuit 610 and the various components thereof can send and receive data via communications interface 640. Communications interface 640 may provide means for communicating with other devices or equipment via an internet or intranet network, such as network 504. In some embodiments, communications interface 640 may include a wired and/or wireless interface in addition to other types of communications interfaces (e.g., BACnet, Modbus, LonWorks, DeviceNet, XML, etc.). Communications interface 640 may include, for example, a wireless connection such as WiFi, cellular, WAN, Bluetooth, etc., or a wired connection such as Ethernet.

Still referring to FIG. 6, memory 620 is shown to include an alarm manager 622. Alarm manager 622 may receive alarm data from any number of controllers (e.g., controllers 510-514) and process the alarm data in a number of ways. Generally, alarm manager 622 receives alarm data from controllers 510-514 via communications interface 640. In some embodiments, alarm data received by alarm manager 622 may include data or information on a plurality of alarms for one or more devices (e.g., devices 520-536) associated with a particular controller. For example, controller 510 may send alarm data to alarm manager 622 that includes data on a first alarm for device 520 and a second alarm for device 522. In this regard, alarm manager may receive “bundled” or combined alarm data from controllers 510-514. In such embodiments, alarm manager 622 may identify and/or extract data or information associated with each individual alarm of the alarm data. To continue the previous example, alarm manager 622 may extract data associate with the first alarm and the second alarm from the alarm data.

In some embodiments, alarm manager 622 may convert alarm data from a first format into a second format. For example, alarm manager 622 may receive alarm data from controller 510 in a first format and convert the alarm data into a second format for further processing and/or storage. In some embodiments, alarm data may be received from controllers 510-514 in a JavaScript Object Notation (JSON) format, and alarm manager 622 may convert the alarm data to a second format or may extract particular information from the JSON formatted alarm data.

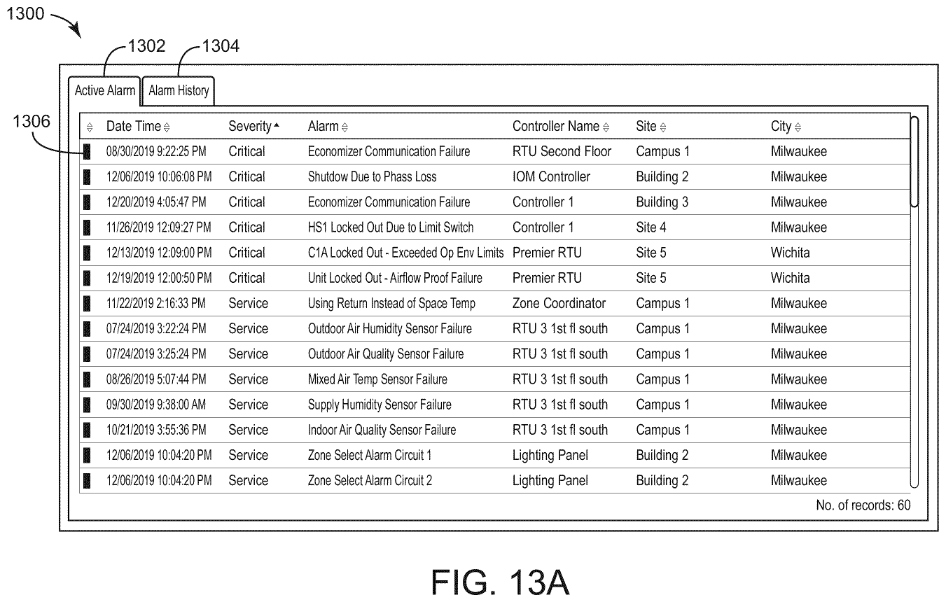

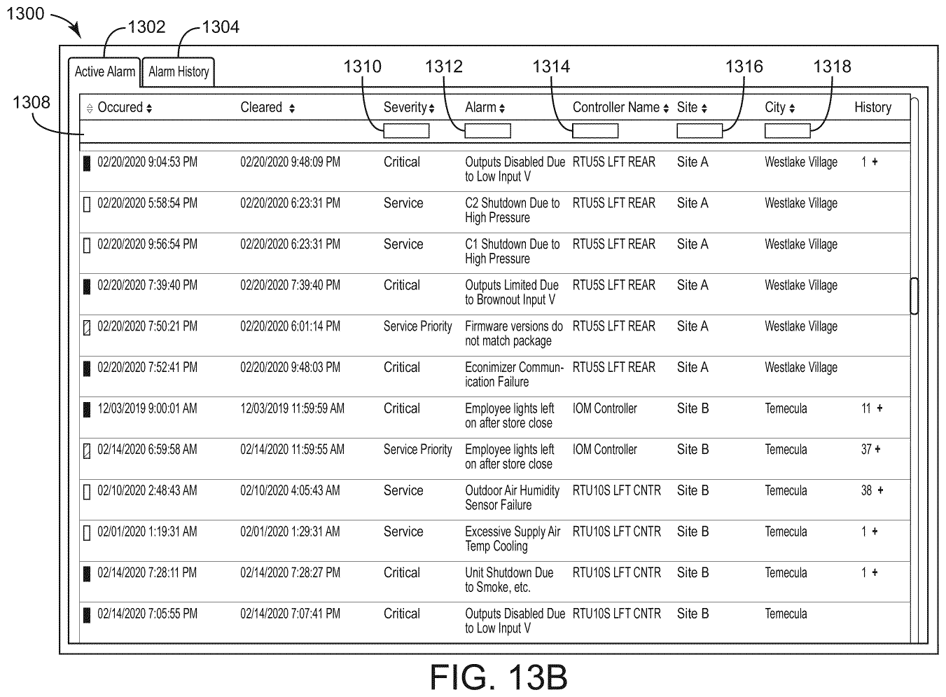

In some embodiments, alarm manager 622 may decode alarm data (e.g., received in a first format such as JSON) by processing the alarm data and/or individual alarms of the alarm data to extract or determine particular parameters or information about the alarm data. For example, alarm data may be decoded to determine an alarm message, an alarm type, a priority, an alarm creation date and time, and, in some cases, an alarm resolve date and time for each associated alarm. In some embodiments, a variety of information may be extracted from the alarm data, such as any of the information presented in FIG. 13. Alarm manager 622 may store the processed, decoded, and/or extracted alarm data in a database 628, and/or may transmit the alarm data to a data analyzer 624. In some embodiments, alarm manager 622 also retrieves stored alarm data from database 628, as described in detail below.

Data analyzer 624 may receive preprocessed alarm data from alarm manager 622 for further processing before storing the alarm data in database 628. In some embodiments, data analyzer 624 maps the alarm data to an associated device (e.g., device 520-536) or equipment. For example, a first alarm of the alarm data may include a tag or an identifier that indicates the device experiencing the first alarm. Data analyzer 624 may determine, from the alarm data and/or based on the information extracted by alarm manager 622, the device and map the first alarm and/or the alarm data to the first device.

In some embodiments, data analyzer 624 may map alarm data to a respective controller (e.g., controller 510-514) that transmitted the alarm data. Mapping the alarm data may include associating or matching the alarm data to the associated device or controller such as with a pointer (e.g., in software), by adding a tag or identifier to the alarm data, generating a new data structure for the alarm data that includes an indication of the device or controller, or by any other method of associating the alarm data with a respective control or device. In some embodiments, data analyzer 624 may store the mapped alarm data in database 628. Likewise, data analyzer 624 may also retrieve previously mapped or unmapped data (e.g., stored by alarm manager 622 without mapping) from database 628.

Database 628 can be configured to store and maintain alarm data after being received and processed by alarm manager 622. For example, database 628 can generally maintain historical data alarm data, including alarm messages, types, priorities and severities, creation and resolve dates and times, associated site or geographic location data, associated controller identifiers, mapping data, etc. It will be appreciated that database 628 can be implemented as a single database or multiple separate databases working together. In some embodiments, database 628 may be a separate (i.e., remote) server or database in communication with enterprise manager 502 via network 504. As described briefly above, alarm manager 622 and/or data analyzer 624 may store and/or retrieve alarm data from database 628.

Memory is also shown to include a user interface (UI) generator 626. UI generator 626 may be configured to generate a user interface based on the stored and/or received alarm data. The user interface generated by UI generator 626 may be an interactive visual representation of a variety of information associated with system 500, including graphical and textual elements. For example, the user interface may include energy consumption data, thermal data, location data, equipment (e.g., device 520-536) operating states and parameters, alarm data, etc. In some embodiments, UI generator 626 may generate a user interface based on alarm data received from alarm manager 622 and/or data analyzer 624. The user interface may be presented via user device 650.

In some embodiments, UI generator 626 may be implemented as a webserver that can store, process, and deliver web pages (e.g., HTML documents) to a web browser of a user device 650, or as an application on a user device 650 (e.g., desktop application, mobile application), for example. In some embodiments, UI generator 626 may receive user inputs (e.g., HTTP requests) and, in response to the user inputs, may reconfigure the user interface and/or generate a new user interface.

User device 650 may be any electronic device that allows a user to interact with enterprise manager 502, such as through a user interface. Examples of user devices include, but are not limited to, mobile phones, electronic tablets, laptops, desktop computers, workstations, and other types of electronic devices. User device 650 may be similar to client device 368 as described above, for example. User device 650 may display the user interface generated by UI generator 626 on a display, thereby enabling a user to easily view alarm data and other data associated with system 500.

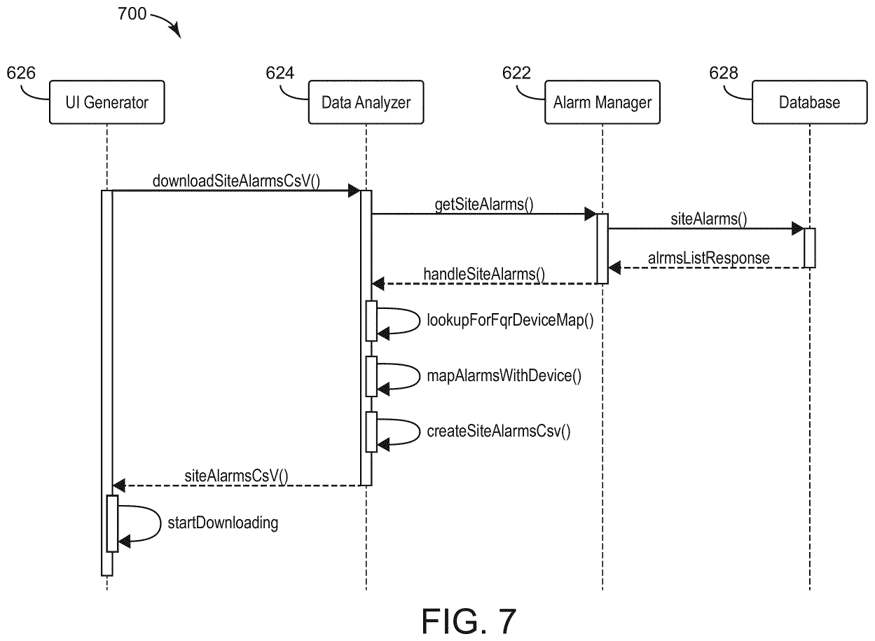

Referring now to FIG. 7, an architecture 700 implemented by enterprise manager 502 is shown, according to some embodiments. Architecture 700 may illustrate the generation of a user interface, such as by UI generator 626, based on alarm data received from multiple controllers and/or devices (e.g., controllers 510-514). More generally, architecture 700 may illustrate the flow of data and corresponding processes implemented by the various components of enterprise manager 502 in generating a user interface for presenting aggregate (i.e., combined) alarm data. In some embodiments, architecture 700 may be implemented based on a user input to a user interface, at a regular time interval, upon initialization, or anytime an alarm or alarm data is received by enterprise manager 502.

In some embodiments, UI generator 626 may initiate the generation of a user interface based on a user input or based on another indication. For example, UI generator 626 may initiate the generation of the user interface when system 500 and/or enterprise manager 502 initializes (i.e., at start-up). In another example, generator 626 may initiate the generation of the user interface when a user navigates to a particular dashboard or interface on a user device. In yet another example, generator 626 may initiate the generation of a new user interface when the user interacts with an initial or first user interface. In such embodiments, where generator 626 initiates the generation of the user interface, UI generator 626 may transmit a “downloadSiteAlarmCsv( )” request to data analyzer 624.

In some embodiments, the request transmitted by UI generator 626 may include an indication of particular alarm data to retrieve. For example, a user input may include a filter parameter for filtering the alarm data displayed on the user interface, and the “downloadSiteAlarmCsv( )” request may include an indicator that only alarm data corresponding to the filter parameter is requested. Upon receiving the request, data analyzer 624 may generate and transmit a “getSiteAlarms( )” request to alarm manager 622. Subsequently, alarm manager 622 is shown to generate and transmit a “siteAlarms( )” request to database 628. In response, database 628 may retrieve and/or compile the requested alarm data.

Database 628 may transmit an “alrmsListResponse” response that includes the requested alarm data. Upon receiving the response, alarm manager 622 may generate and transmit a “handleSiteAlarms( )” response and transmit the response to data analyzer 624. Subsequently, data analyzer 624 may perform a number of functions utilizing the received alarm data. As shown, for example, data analyzer may initiate a lookup function (“lookupForFqrDeviceMap( )”) that determines or generates a map of fully qualified references (FQRs) (i.e., fully qualified names) associated with devices (e.g., devices 520-536 and/or controllers 510-514). Data analyzer 624 may then map the received alarm data with associated devices, based on the map of FQRs. As described above, mapping the received alarm data may include associating an alarm of the alarm data or the alarm data with a device or controller that is experiencing the alarm or, in the case of historical alarm data, which experienced the alarm.

Subsequently, data analyzer 624 may generate a list of alarms based on the mapped alarm data (“createSiteAlarmCsv( )”). The list of alarm data (“siteAlarmCsv”) may be transmitted to UI generator 626 (i.e., download by UI generator 626), where UI generator 626 may utilize the received list of alarm data to generate a user interface. The user interface may then be presented to a user via user device 650. In some embodiments, the user may interact with the interface, thereby causing UI generator 626 to reconfigure the user interface or request new alarm data.

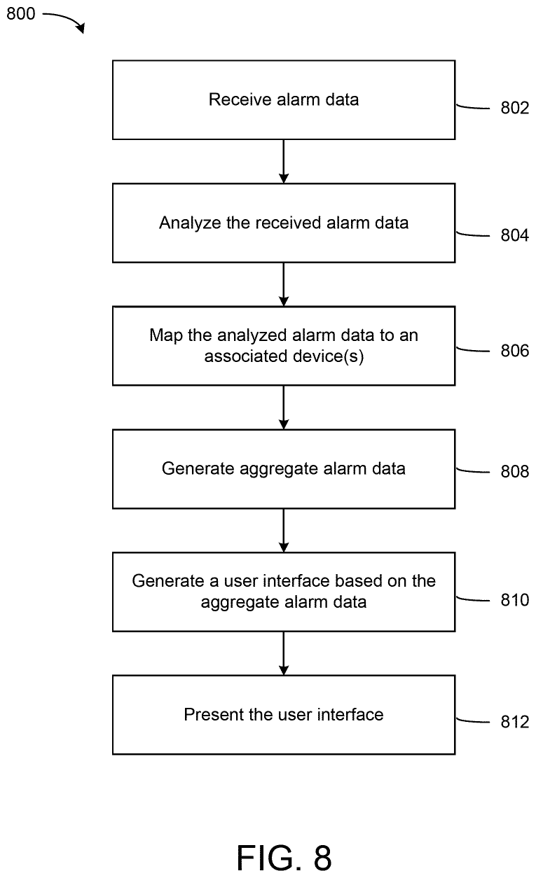

Referring now to FIG. 8, a process 800 for aggregating alarm data is shown, according to some embodiments. Process 800 may generally describe aggregating alarm data from a plurality of controllers (e.g., associated with a plurality of devices, buildings, subsystems, sites, etc.) for presenting via a single interface. More specifically, process 800 may generally describe a process of receiving alarm data from multiple controllers, processing the alarm data, aggregating the alarm data, and generating a user interface from the aggregate alarm data. In some embodiments, process 800 may be implemented by enterprise manager 502.

At step 802, alarm data is received from a plurality of controllers (i.e., device controllers) associated with a plurality of equipment (i.e., devices) and/or sites (e.g., buildings, campuses, etc.). For example, alarm data may be received by enterprise manager 502 (e.g., by alarm manager 622) from one or more of controllers 510-514. Generally, the alarm data may include any number of alarms associated with any number of controllers. For example, the alarm data may include dozens of alarms associated with a dozens of different controllers. The alarm data may be associated with different types of equipment (e.g., HVAC, lighting, electrical, etc.), in some embodiments. Alarm data may be received from a plurality of controllers associated with distributed (i.e., remote) systems or subsystems. More generally, the alarm data may be received from various controllers at different geographic locations.

As an example, first alarm data may be received from a first controller (e.g., controller 510) of a first subsystem (e.g., an HVAC subsystem), and second alarm data may be received from a second controller (e.g., controller 512) of a second subsystem (e.g., a security subsystem). In some embodiments, the first subsystem and, thereby the first controller, may be associated with a first geographic location and the second subsystem and second controller may be associated with a second geographic location. More generally, the first and second subsystems may be associated with building at separate geographic locations. Likewise, in some embodiments, the first subsystem and the second subsystem may be disparate (i.e., different) types of subsystems or may be the same type of subsystem. In this example, the first alarm data may indicate one or more alarm conditions for one or more devices of the first subsystem while the second alarm data may indicate one or more alarm conditions for one or more devices of the second subsystem.

At step 804, the received alarm data is analyzed. In some embodiments, the alarm data is analyzed by alarm manager 622 and/or data analyzer 624, as described above. Analyzing the alarm data may include determining various parameters of each alarm of the alarm data such as a priority, a message, a location, an associated device, a severity, a time and date, etc., for each alarm. In some embodiments, analyzing the alarm data may include decoding the alarm data or converting the alarm data to a second format. Decoding the alarm data may include extracting, from the alarm data, the various parameters associated with each individual alarm. To continue the example from above, the first alarm data may be analyze by extracting individual alarms and determining, for each alarm, a priority, a message, an associated device and device/subsystem location, and/or a creation time and date. Likewise, the second alarm data may be analyzed in a similar manner.

In some embodiments, after the received alarm data is decoded and/or analyzed, the preprocessed alarm data is stored in a database (e.g., database 628). In such embodiments, the alarm data may be stored in a list or a specific data structure, where the extracted or decoded data is associated with each specific alarm. In this manner, the database may include a list of each current and/or historical alarm for all controllers and/or devices associated with the system (e.g., system 500) and the associated details (i.e., information, parameters) associated with each current and/or historical alarm.

At step 806, the analyzed (i.e., preprocessed) alarm data may be mapped to associated devices. In some embodiments, the alarm data may be mapped by data analyzer 624. Mapping the alarm data may include generating or retrieving a lookup table or an FQR device map (e.g., as described with respect to FIG. 7) and mapping individual alarms of the alarm data to a respective controller (e.g., controller 510-514) that originally indicated the alarm. Mapping the alarm data may include associating or matching the alarm data to the associated device or controller such as with a pointer (e.g., in software), by adding a tag or identifier to the alarm data, generating a new data structure for the alarm data that includes an indication of the device or controller, or by any other method of associating the alarm data with a respective control or device. In some embodiments, the mapped data may be stored in a database, or alarm data stored in the databased may be retrieved for mapping.

At step 808, aggregate alarm data is generated based on the preprocessed and/or mapped alarm data. In some embodiments, the alarm data may be aggregated by alarm manager 622 in conjunction with data analyzer 624. Generally, aggregating alarm data includes combining alarm data from a plurality of controllers monitored or controlled by an enterprise manager. Aggregating the alarm data may involve a number of additional steps, such as identifying the alarm data to aggregate, retrieving the identified alarm data from a database, and combining the alarm data to generate new aggregate alarm data.

In some embodiments, all current and/or historical alarm data stored in a database may be identified for initial aggregation (e.g., before a filtering parameter is determined). In other embodiments, only a portion of alarm data (e.g., stored in database 628) may be aggregated (e.g., based on a filtering parameter). Filtering the alarm data is described in detail below, with respect to FIGS. 13A and 13B. After identifying the appropriate alarm data for aggregation, the identified data may be retrieved from a database (e.g., database 628). As described above, the retrieved the alarm data may include additional information relating to the alarms of the alarm data, such as messages, priorities, etc.

In some embodiments, the retrieved alarm data was previously mapped at step 806. In other embodiments, alarm data is stored after analyzing, at step 804, and the retrieved alarm data for aggregation is mapped according to step 806. In either embodiment the retrieve alarm data, including mapping, may be combined to generate the aggregate alarm data. In this manner, alarm data from a plurality of controls for a plurality of subsystems may be aggregated to provide an overview of the alarms for a plurality of system/controllers managed by an enterprise manager, such as system 500.

To continue the previous example, the first alarm data and the second alarm data may be identified for aggregation. In one scenario, while the first alarm data and the second alarm data are from controllers of different types of subsystems (e.g., HVAC and security), the first and second alarm data may be selected in another way. For example, the first and second data may be aggregated to generate initial aggregate alarm data that includes all the alarms of an enterprise management system, without filtering. In another example, the first and second data may be from controllers located in a similar building type (e.g., hospital, library, etc.), country, state, zip code, etc. In any case, the first and second alarm data, after having been identified, may be retrieved from a database.

In some embodiments, the first and second alarm data may be mapped to respective controllers or equipment, as described above, if step 806 was not completed prior to the first and second alarm data being stored. Subsequently, the first and second alarm data is aggregated (i.e., combined) to determine a total number of alarms, and to determine other metrics such as number of alarms by priority, equipment type, location, etc.

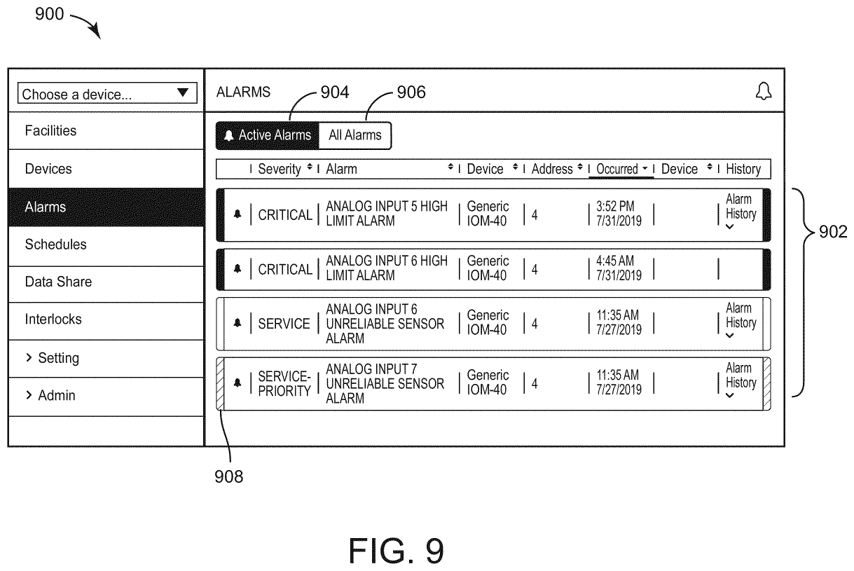

At step 810, a user interface is generated based on the aggregate alarm data. The user interface may be generated by UI generator 626, in some embodiments. The user interface may include a visual indication of a total number of alarms for all of the controllers monitored and/or controlled by an enterprise manager. In some embodiments, the user interface may provide a visual representation of the severity or priority of the aggregate alarm data as well. In this manner the user interface may provide an intuitive interface for a user (e.g., an administrator or manager) of an enterprise management system (e.g., system 500) to monitor alarm data for multiple controllers from a single view. At step 812, the user interface is presented. The user interface may be presented via user device 650, for example. Examples of the user interfaces generated at step 810 and presented at step 812 are described below with respect to FIGS. 9-13.

In some embodiments, an automated control action may be also be generated and/or determined based on the aggregate alarm data. The automated control action may be generated or determined by alarm manager 622, for example. The automated control action may provide means for correcting an alarm condition or multiple alarm conditions associated with the aggregate alarm data. For example, the automated control action may include automatically scheduling maintained, generating a work order, generating and presenting an alert via a user device, generating and transmitting a text or email message to a user, initiating a phone call with the user, etc. In some embodiments, the automated control action may include generating and transmitting a control command to a controller of the enterprise management system. The control command may include a change to a parameter of the controller or a device connect to the control. The change in parameter may help the device or controller to recover from the alarm.

Advantageously, aggregating alarm data from multiple different controllers of different types and/or geographic locations, such as by process 800, may provide a user (i.e., system manager or administrator) with a single, intuitive interface for viewing and reacting to alarms throughout an entire enterprise management system. The user may not necessarily need to be on-site or collocated with a building or a controller to view and address alarms. Additionally, presenting a user interface with aggregate alarm data may reduce the time and effort required to navigate through various enterprise management system interfaces (i.e., dashboards), such as for each individual controller, to view and address alarms. In other words, the user interface generated by process 800 may be more user-friendly and require less navigation by the user to view desired alarm data, thereby increasing the efficiency and effectiveness with which the user can manage sites and equipment of the enterprise management system.

Referring now to FIG. 9, an example user interface 900 for presenting aggregate alarm data is shown, according to some embodiments. Interface 900 may be an example of a user interface generated by UI generator 626, for example, based on alarm data aggregated according to process 800. Interface 900 is shown to include a list 902 of active (i.e., current) alarms for an enterprise management system (e.g., system 500). In other words, list 902 is a list of aggregate alarm data for the system. List 902 may be presented by selected an active alarms button 904. In some embodiments, an all alarm button 906 may be selected from interface 900 to view a list of all alarm for the system, including historical alarms.

An example alarm 908 is shown to include a variety of information related to the alarm. For example, alarm 908 is shown to include a severity (i.e., a priority) of the alarm (“Service-Priority”). The severity of the alarm may indicate how urgent the alarm is (e.g., to correct) or the significance of the alarm. In some cases, an alarm may not be urgent, as a device or equipment experiencing the alarm may function normally under the alarm condition (e.g., “Priority”). However, in other cases, a device or equipment may not function at all, or may function with reduced efficiency, possibly affecting other equipment or leading to further damage. In such cases, an alarm may have a higher priority (e.g., “Critical”).

Alarm 908 is also shown to include an alarm message (i.e., a description) that indicates what caused the alarm, or what the alarm is. For example, alarm 908 is shown to be an “Analog Input 7 Unreliable Sensor Alarm”, indicating that an “Analog Input 7” may have a faulty or unreliable sensor. Alarm 908 is shown to include an associated device (e.g., determined by mapping the alarm to a controller) (“Generic IOM-40”), an address (“4”), a time and date of occurrence (“11:35 AM, 7/27/2019”), and a dropdown indicator for viewing a history associated with the alarm. In some embodiments, a time and date that the alarm is cleared may also be populated. In some embodiments, a user may select the dropdown indicator for an alarm to view alarm history, such as past alarm occurrences and previously implemented corrective actions (e.g., maintenance logs, service logs, automated control actions, etc.).

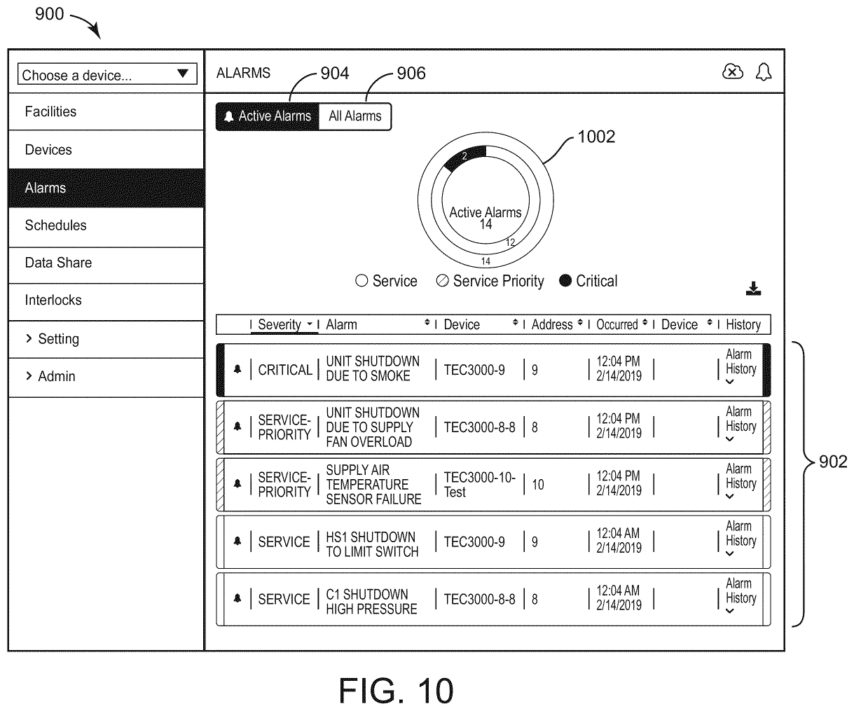

Referring now to FIG. 10, interface 900 is shown in an alternate configuration, according to some embodiments. More specifically, interface 900 is shown with the addition of a graphical element 1002. Graphical element 1002 is a ring chart that may be generated and presented based on the aggregate alarm data. Graphical element 1002 may provide a more intuitive and/or easy-to-understand indication of the total number alarms (e.g., either active or historical). Advantageously, interface 900 and graphical element 1002 may present active or historical alarms (i.e., aggregate alarm data) for a system within a single interface. As shown in FIG. 10, for example, list 902 includes alarms from a plurality of different devices (e.g., “TEC3000-9”, “TEC3000-8-8”, “TEC3000-10-Test”) and with a plurality of different addresses (e.g., “8”, “9”, “10”).

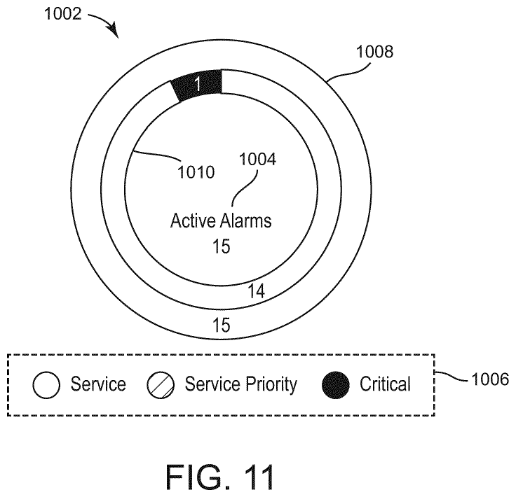

A more detailed illustration of graphical element 1002 is shown in FIG. 11, according to some embodiments. Graphical element 1002 is shown to include an indication 1004 of the total number of alarms (e.g., “15 Active Alarms”). Graphical element 1002 is further shown to include a key 1006 that defines indicators for one or more severity or priority levels associated with the active alarms. As shown, for example, graphical element 1002 includes indicators for “service”, “service-priority”, and “critical” priority levels. An outer ring 1008 of graphical element 1002 indicates the total number of alarms, while an inner ring 1010 indicates a breakdown of the total number of alarms by priority, according to key 1006. In this manner, graphical element provides an easy-to-understand and quick-to-view graphical representation of the total number of alarms and the total number of alarms by type (e.g., priority) for an enterprise management system (e.g., system 500).

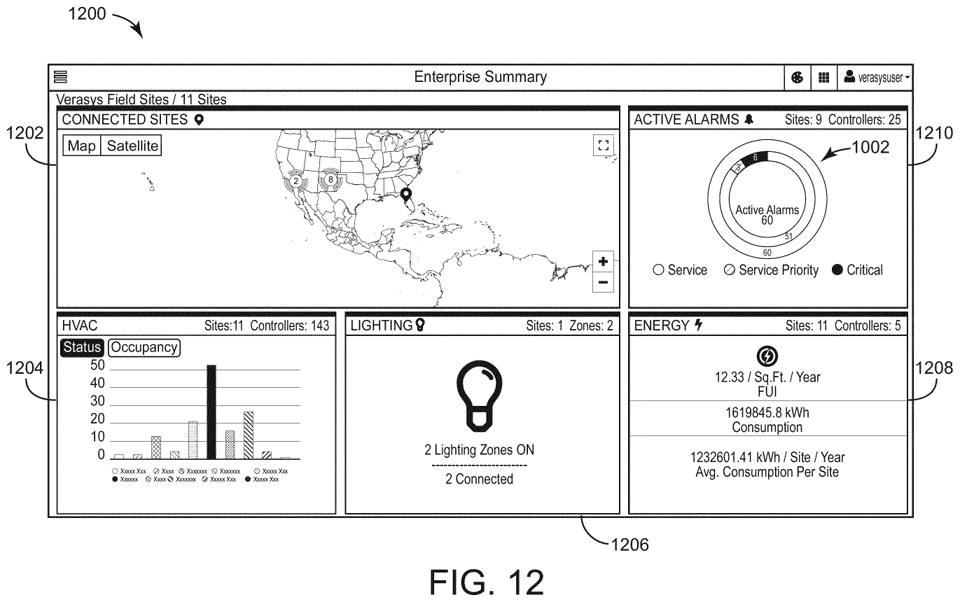

Referring now to FIG. 12, an example user interface 1200 for an enterprise management system is shown, according to some embodiments. Interface 1200 may represent a dashboard (i.e., a landing page, an initial interface) for an enterprise management system such as system 500, for example. Interface 1200 may provide a single interface for a user of the system to view a variety of information relating to subsystems of the enterprise management system. Interface 1200 is shown to include a number of graphical elements for monitoring, controlling, or otherwise interacting with various remote systems (e.g., controllers) of the enterprise management system. In some embodiments, the graphical elements of interface 1200 are reconfigurable based on user inputs.

As shown, interface 1200 includes a first graphical element 1202 that includes a map that further indicates a geographic location of a plurality of sites associated with the enterprise management system. Interface 1200 further includes a second graphical element 1204 that indicates HVAC equipment statuses. More specifically, graphical element 1204 illustrates operating modes of various HVAC equipment managed by the enterprise management system. A third graphical element 1206 illustrates a number of lighting zones and the state of the lighting zones. A fourth graphical element 1208 presents energy consumption for all systems managed by the enterprise management system.

A fifth graphical element 1210 illustrates the total number of alarms for the enterprise management system. As previously described, the total number of alarms may be generated based on aggregate alarm data from a plurality of remote systems and subsystems. Graphical element 1210 is shown to include graphical element 1002, providing a visual of the total number of alarms and the total number of alarms by priority. Graphical element 1210 further presents the total number of sites (“9”) and the total number of controllers (“25”) that are connected to the enterprise management system and/or are providing alarm data.

Any of graphical elements 1202-1210 may be interactive, such that a user may select an element and interact with it. For example, a user may zoom-in on graphical element 1202, or may select graphical element 1206 to identify which of the lighting zones are connected and/or on. In some embodiments, the user may select graphical element 1210 to be presented with further detail on active alarms for the enterprise management system or to navigate to another interface for viewing alarm data. In such embodiments, the user selection may navigate the user to interface 900 described with respect to FIGS. 9-11, or to an example user interface 1300, described below.

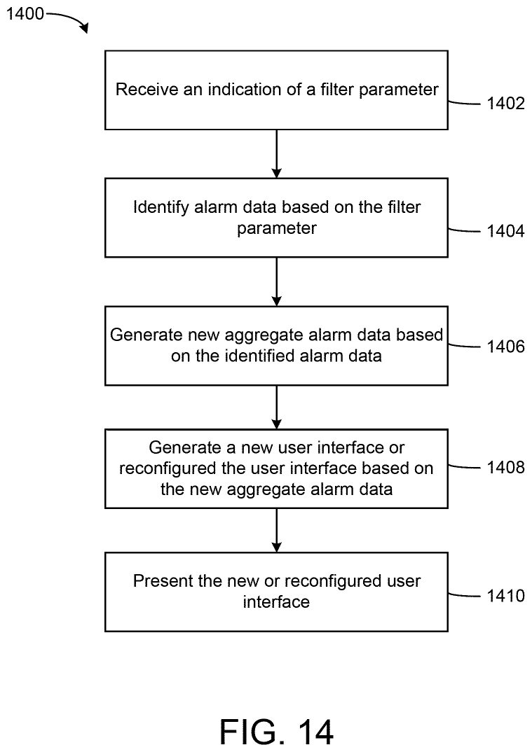

In some embodiments, a user may interact with interface 1200 by entering a filter parameter. In such embodiments, the filter parameter may be selected from a drop down menu, entered in a text entry field, selected from a list, or by any other suitable method. In one example, a user may select an indicator from the map shown in graphical element 1202 to filter the data shown in interface 1200. For example, the user may select a particular indicator located in Kansas. In response, interface 1200 may be updated or reconfigured to display information associated with a single site, or with only the sites located in Kansas. The process of filter aggregate alarm data and/or updating or reconfiguring interface 1200 is described in detail below with respect to FIGS. 14-16.

Referring now to FIGS. 13A and 13B, interface 1300 is shown, according to some embodiments. As described above, a user may navigate to interface 1300 by selecting graphical element 1210, or by another method such as via a navigation bar or a menu of interface 1200 (not shown). Interface 1300 may generally present a textual representation of each alarm of the aggregate alarm data (e.g., presented graphically in interface 1200). In this manner, interface 1300 may provide a detailed interface for analyzing and/or viewing specific alarms and aggregate alarm data.

Interface 1300 is shown to include an active alarm button 1302 and an alarm history button 1304. A user may select either button 1302 or button 1304 to be presented with a corresponding list of alarm data. As shown in FIG. 13A, active alarm button 1302 may be selected to view active alarm data. The active alarm data shown in interface 1300 may be aggregated from multiple controllers, as described above with respect to FIG. 8. For each alarm of the aggregate alarm data, a date and time, a severity (i.e., priority), an alarm type or message, an associated controller name, a site, and a city are listed. Referring to an example alarm 1306 in particular, an “Economizer Communication Failure” alarm is shown. Alarm 1306 is associated with a particular controller, “RTU 1Second Floor” located at site “Plum Media” in “Milwaukee”.

As shown in FIG. 13B, selecting the alarm history button 1304 may present a user with historical alarm data. Historical alarm data may include any alarms previously recorded by an enterprise management system. Additionally, FIG. 13B shows a filter menu 1308 that may be presented when a user selects dropdown arrows next to any of the column headers. It will be appreciated that while menu 1308 is shown in FIG. 13B, menu 1308 may also be displayed when viewing active alarm data as shown in FIG. 13A. Menu 1308 is shown to include a number of parameter entry fields 1310-1318. In each of fields 1310-1318, a use may enter a filter parameter for the corresponding column (i.e., category). As an example, a user may enter a site filter in field 1316, such as “Site A”. In this example, interface 1300 may be filtered (e.g., configured or regenerated) to present only alarm data associated with Site A.

In various other embodiments, a filter parameter may be entered in another way to filter interface 1300. For example, the filter parameter may be selected from a drop down menu, entered in a separate text entry field or search bar, selected from a list, or by any other suitable method. As in a previous example, a user may select an indicator from the map shown in graphical element 1202 of interface 1200. Subsequently, interface 1300 may be updated or reconfigured to display information based on the selected indicator (i.e., the filter parameter). The process of filter aggregate alarm data and/or updating or reconfiguring interface 1300 is described in detail below with respect to FIGS. 14-16.

Referring now to FIG. 14, a process 1400 for filtering aggregate alarm data is shown, according to various embodiments. Process 1400 generally describes a method of filtering a user interface that presents aggregate alarm data. Process 1400 may be implemented by enterprise manager 502, for example, prior to the implementation of process 800 or after process 800 is implemented. Generally process 1400 is implemented after generating an initial interface (e.g., according to process 800). Process 1400 may be imitated based on a user input, for example.

At step 1402, an indication of a filter parameter is received. In some embodiments, the filter parameter is received via a user input. The filter parameter may indicate a parameter that the user wishes to filter the aggregate alarm data by. For example, a user may enter a filter parameter such as a geographic location (e.g., a city, a state, a country, zipcode, etc.), a type of equipment, a priority, a controller, a type of building or site (e.g., hospital, office building, etc.), an alarm type, etc., to filter the aggregate alarm data by location, equipment type, priority, etc.

In some embodiments, the filter parameter is received (e.g., from an external authentication system) or automatically generated (e.g., by alarm manager 622 and/or data analyzer 622) based on an access level of a user. For example, a user of an enterprise management system may be permitted to access only certain alarm data or alarm data for certain sites/controllers. In this example, the user access level may be the filter parameter, and the aggregate alarm data for the entire enterprise management system may be filter based on the access level. In a more specific example, a user may only have access to view alarm data associated with controls at a specific geographic location and/or of a particular subsystem type. The aggregate alarm data may then be filtered, based on the access level, so that the user may view only allowed alarm data.

At step 1404, the filter parameter is used to identify corresponding alarm data. As an example, based on a filtering parameter that indicates a particular geographic location, only alarm data associated with the particular geographic location may be identified. In another example, based on the user access level, aggregate alarm data may be identified that corresponds to the user access level. To continue the example described in process 800, a user may enter a filter parameter indicating a geographic location (e.g., Wisconsin) to filter the first and second alarm data by. The filter parameter may be used to identify which of the first and/or second alarm data may be associated with a controller located in Wisconsin. Subsequently, the identified first or second alarm data that fits the filter parameter may be retrieved from a database.

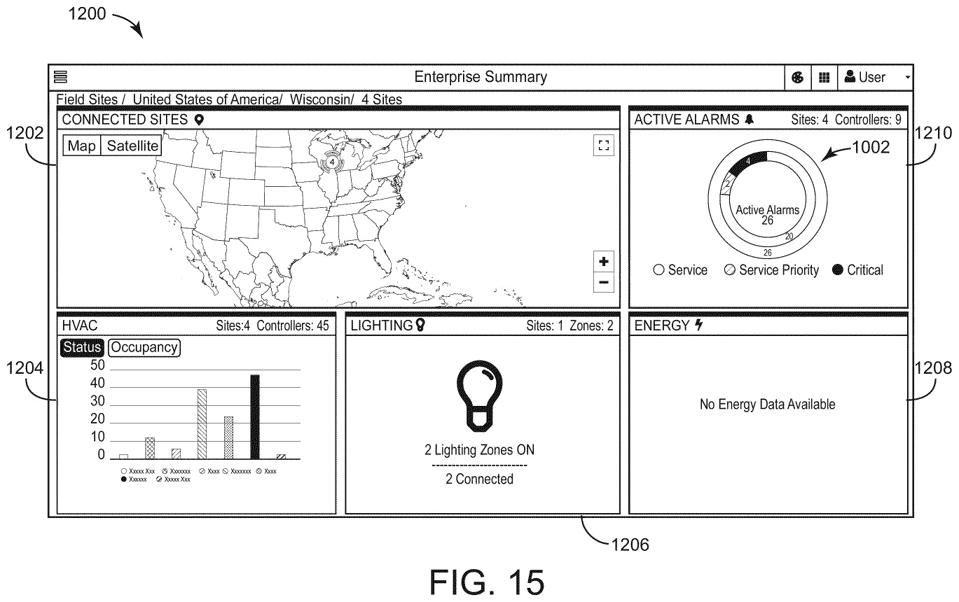

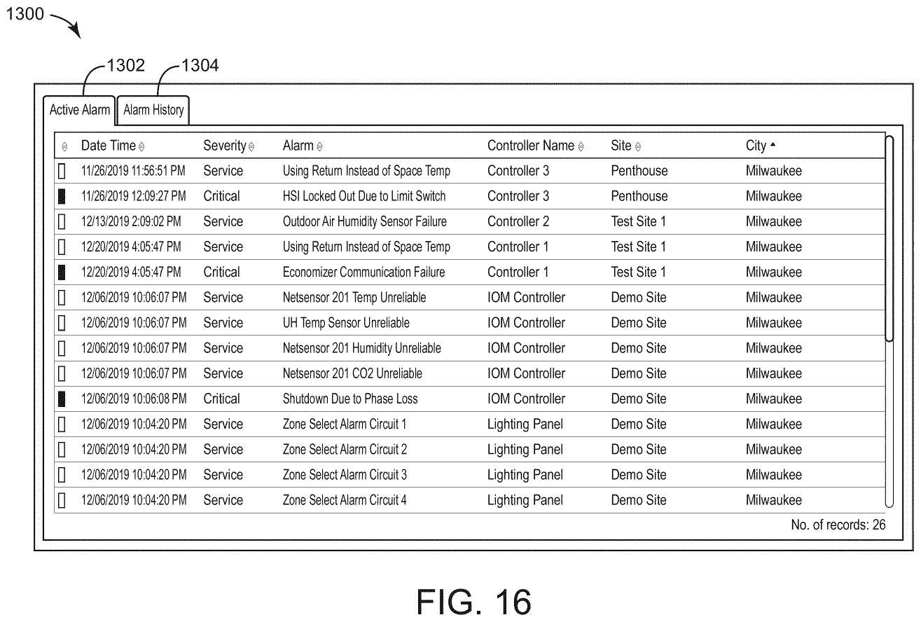

At step 1406, new aggregate alarm data is generated based on the filtering parameters. The new aggregate alarm data may be generated according to step 808 of process 800, described above, for example. Subsequently, at step 1408 a new user interface may be generated, such as described in step 810 of process 800, or a first user interface is reconfigured based on the new aggregate alarm data. For example, the first user interface may be repopulated with the new aggregate alarm data, or a graphical element (e.g., graphical element 1002) may be updated or replaced. At step 1410, the new or reconfigured user interface is presented via a user device (e.g., user device 650). Examples of the new or reconfigured user interface are described below, with respect to FIGS. 15 and 16.

Referring now to FIG. 15, interface 1200 is shown with a filter parameter applied, according to some embodiments. FIG. 15 may show a configuration of interface 1200 is a geographic filter parameter applied, for example. More specifically, FIG. 15 shows interface 1200 is a geographic filter parameter of “Wisconsin” applied, where only controllers located in Wisconsin are present. As described above, interface 1200 may be reconfigured based on the filter parameter, where one or more of the graphical elements 1202-1210 are updated or replaced (e.g., regenerated) based on the new aggregate alarm data, or the user interface of FIG. 15 may be a completely new interface generated based on the new aggregate alarm data. In either case, interface 1200 is dynamically updated based on the new aggregate alarm data. As shown, for example, graphical elements 1202-1210 are shown to display different information that that shown in FIG. 12.

More specifically, graphical element 1202 shows a map presenting the geographic location of a plurality of controllers or sites located in Wisconsin (e.g., according to the filter parameter). Each of graphical elements 1204-1210 are shown to be filtered as well, presenting less or different data than that shown in FIG. 12. Most notably, however, is graphical element 1210 that presents only the aggregate alarm data for controllers located in Wisconsin. Specifically, the number of sites aggregated to generate graphical element 1210 has been reduced from 9 to 4, and the number of controllers has been reduced from 25 to 9. Accordingly, the total number of active alarms has been reduced from 60 to 26.

As described with respect to FIG. 12, a user may select graphical element 1210 to navigate to a list view (e.g., interface 1300) of alarm data, or may navigate to the list view another way. As show in FIG. 16, for example, interface 1300 is shown with the filter parameter applied. Much like interface 1200, interface 1300 may be reconfigured based on the filter parameter, where the list of aggregate alarm data is updated or replaced (e.g., regenerated) based on the new aggregate alarm data, or the user interface of FIG. 16 may be a completely new interface generated based on the new aggregate alarm data. In either case, interface 1300 is dynamically updated based on the new aggregate alarm data. As shown, the list of aggregate alarm data has been filtered by location, such that the only alarm data corresponding to controllers in Wisconsin is presented.

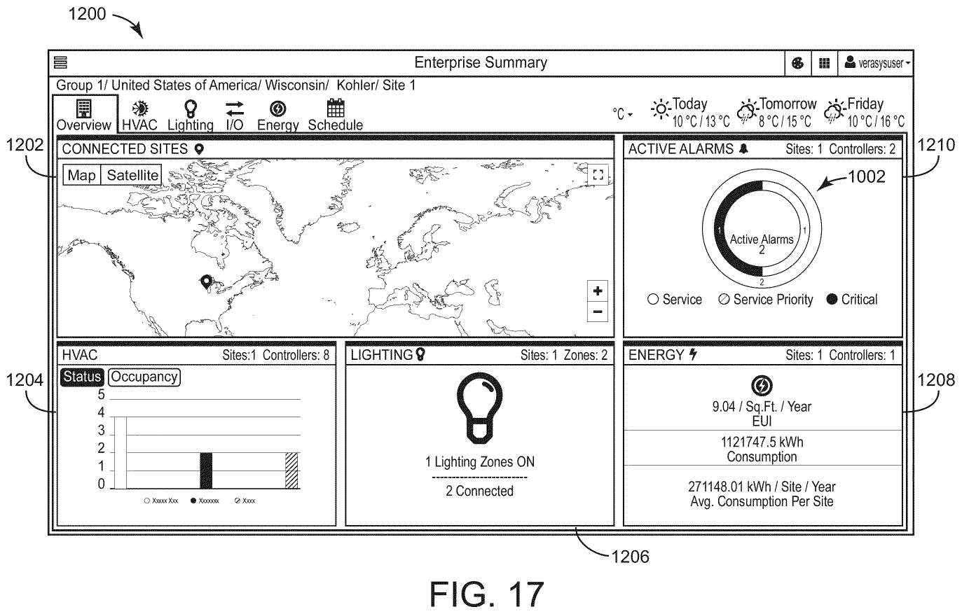

Referring now to FIG. 17, interface 1200 is shown after having been filtered to present aggregate data from a single site (e.g., in Wisconsin). As described above with respect to FIG. 15, interface 1200 may be reconfigured based on a filter parameter (e.g., a single site) such that one or more of the graphical elements 1202-1210 are updated or replaced (e.g., regenerated) based on the new aggregate alarm data, or the user interface of FIG. 17 may be a completely new interface generated based on the new aggregate alarm data. In either case, interface 1200 is dynamically updated based on the new aggregate alarm data. As shown, for example, graphical elements 1202-1210 are shown to display different information that that shown in FIG. 12 and/or FIG. 15.

More specifically, graphical element 1202 shows a map presenting the geographic location of a single controller (i.e., site) located in Wisconsin. Each of graphical elements 1204-1210 are shown to be filtered as well, presenting less data than that shown in FIG. 12 and FIG. 15. For example, graphical element 1202 shows a single site, graphical element presents HVAC data for a single building, etc. Most notably, however, graphical element 1210 presents only aggregate alarm data for equipment associated with the single site in Wisconsin. In this example, the single site has two controllers (e.g., for two buildings, two subsystems, etc.) As shown, the number of sites aggregated to generate graphical element 1210 has been reduced from 4 (e.g., in FIG. 15) to 1, and the number of controllers has been reduced from 9 to 2. Accordingly, the total number of active alarms has been reduced from 26 to 2.

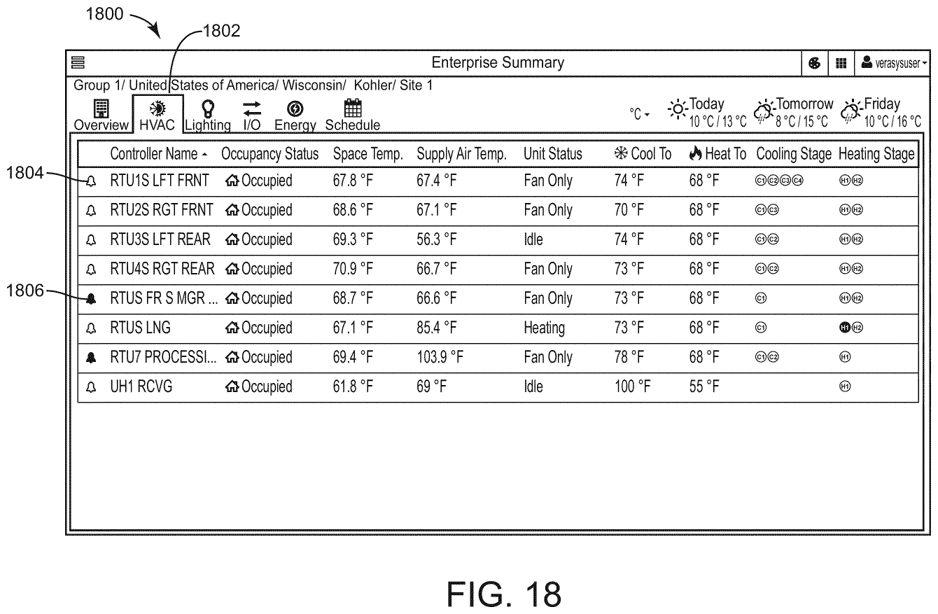

Referring now to FIG. 18, a user interface 1800 for presenting aggregate alarm data for a single site is shown, according to some embodiments. In other words, interface 1800 may present aggregate alarm data filtered from an enterprise level down to an equipment level. Interface 1800 may be presented when a user filters aggregate alarm data for a single site, as described above with respect to FIG. 17, for example. In some embodiments, a user may navigate to interface 1800 from interface 1200. For example, a user may select one of graphical element 1202-1210 Interface 1800 is shown to include a number of tabs for viewing aggregate data for different subsystems of the single site. As shown, an HVAC tab 1802 is selected to present HVAC alarm data for the site. Selecting HVAC tab 1802 may present a list HVAC equipment such as HVAC controllers, sensors, or devices.

As shown, a variety of information is presented for a first example device 1804 (“RTU1S.LFT.FRNT”) including an occupancy status, space temperature, supply air temperature, unit status, temperature setpoints, and cooling/heating stage data. Similarly, the same variety of information is presented for a second example device 1806. However, unlike device 1804, device 1806 is shown to include an alarm. The alarm is evident based on the alarm icon presented next to the controller name for device 1806. In this manner, interface 1800 may present a single interface for a user to view alarm data for a variety of equipment of a site.

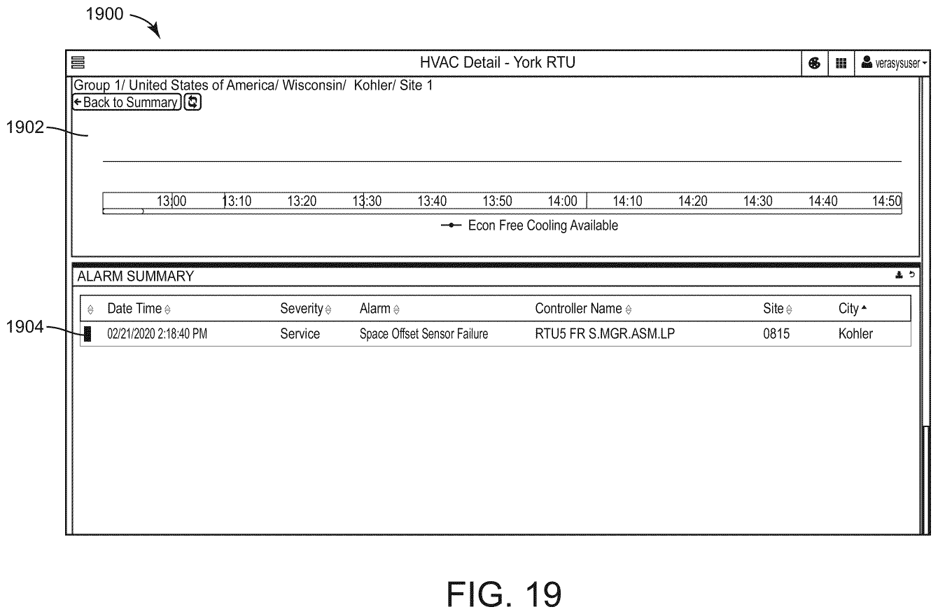

Referring now to FIG. 19, a user interface 1900 for presenting alarm data for a particular building device is shown, according to some embodiments. Interface 1900 may be presented when a single device is selected (e.g., from interface 1800) or one of interfaces 1200 or 1300 are filtered down to the device level. Interface 1900 is shown to include a trend graph 1902 that may present a variety of trend information for a selected device. As shown, for example, “Econ Free Cooling Available” is presented for a selected RTU (e.g., RTU 5 as shown in interface 1800). Additionally, an alarm summary 1904 is shown for the individual device that presents active and/or historical alarm data for the device. As shown, for example, the selected RTU is experiencing a “Space Offset Sensor Failure”.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. An enterprise management system comprising:
a first subsystem located at a first geographic location, the first subsystem comprising a first building device;
a second subsystem located at a second geographic location, the first geographic location different than the second geographic location and the second subsystem comprising a second building device; and
one or more memory devices having instructions stored thereon that, when executed by one or more processors, cause the one or more processors to perform operations comprising:
receiving first alarm data from the first subsystem, the first alarm data indicating an alarm condition for the first building device;
receiving second alarm data from the second subsystem, the second alarm data indicating an alarm condition for the second building device; and
providing aggregate alarm data on a user interface based on the first alarm data and the second alarm data.

2. The system of claim 1, the operations further comprising:
receiving a user input indicating a parameter for filtering the aggregate alarm data;
providing new aggregate alarm data based on the parameter;
providing a new user interface configured to present the new aggregate alarm data; and
displaying the new user interface via a user device.

3. The system of claim 1, the operations further comprising:
determining an access level of a user of the user device; and
filtering the aggregate alarm data based on the access level of the user.

4. The system of claim 1, wherein the first subsystem and the second subsystem are different types of building subsystems.

5. The system of claim 1, the operations further comprising:
mapping at least one of the first alarm data or the second alarm data to an associated one of the first building device or the second building device.

6. The system of claim 1, the operations further comprising:
decoding the first alarm data to determine an alarm message, a severity, and a time of occurrence for the alarm condition associated with the first building device; and
decoding the second alarm data to determine an alarm message, a severity, and a time of occurrence for the alarm condition associated with the second building device.

7. The system of claim 1, the operations further comprising:
determining an automated control action based on at least one of the first alarm data or the second alarm data; and
initiating the automated control action.

8. The system of claim 1, the operations further comprising determining a severity for each of the first alarm data and the second alarm data, wherein the aggregate alarm data further indicates a total number of alarms for the system by severity.

9. The system of claim 8, wherein the aggregate alarm data is displayed as a graphical element, the graphical element presenting the total number of alarms for the system by severity.

10. A method comprising:
receiving first alarm data for a first subsystem located at a first geographic location, the first alarm data indicating an alarm condition for a first device of the first subsystem;
receiving second alarm data for a second subsystem located at a second geographic location, the second geographic location different than the first geographic location and the second alarm data indicating an alarm condition for a second device of the second subsystem;
generating aggregate alarm data based on the first alarm data and the second alarm data;
generating a user interface configured to present the aggregate alarm data;
displaying the user interface via a user device;
receiving, via the user interface, a user input indicating a parameter for filtering the aggregate alarm data; and
reconfiguring the user interface based on the user input.

11. The method of claim 10, further comprising:
determining an access level of a user of the user device; and
filtering the aggregate alarm data based on the access level of the user.

12. The method of claim 10, wherein the first subsystem and the second subsystem are different types of building subsystems.

13. The method of claim 10, further comprising mapping at least one of the first alarm data or the second alarm data to an associated one of the first device or the second device.

14. The method of claim 10, further comprising:
decoding the first alarm data to determine an alarm message, a severity, and a time of occurrence for the alarm condition associated with the first device; and
decoding the second alarm data to determine an alarm message, a severity, and a time of occurrence for the alarm condition associated with the second device.

15. The method of claim 10, further comprising:
determining an automated control action based on at least one of the first alarm data or the second alarm data; and
initiating the automated control action.

16. The method of claim 10, wherein the aggregate alarm data is displayed as a graphical element, the graphical element presenting the total number of alarms for the system based on severity.

17. An enterprise management system comprising:
a first subsystem located at a first geographic location;
a second subsystem located at a second geographic location, the first geographic location different than the second geographic location; and
a server configured to:
receive first alarm data indicating an alarm condition for the first subsystem;
receive second alarm data indicating an alarm condition for the second subsystem;
generate aggregate alarm data based on the first alarm data and the second alarm data;
display a user interface configured to present the aggregate alarm data via a user device;
receive, via the user interface, a user input indicating a parameter for filtering the aggregate alarm data; and
reconfigure the user interface based on the user input.

18. The system of claim 17, the server configured to:
determine an automated control action based on at least one of the first alarm data or the second alarm data; and
initiate the automated control action.

19. The system of claim 17, the server configured to:
determine an access level of a user of the user device; and
filter the aggregate alarm data based on the access level of the user.

20. The system of claim 17, wherein the first subsystem and the second subsystem are different types of building subsystems.
